(19) United States
(12) Patent Application Publication
(10) Pub. No.: US 2003/0124322 A1
(43) Pub. Date: Jul. 3, 2003

(54) Image formed product

(76) Inventor: Masayasu Yamazaki, Tokyo-to (JP)

Correspondence Address: Richard J. Streit, Ladas & Parry, Suite 1200, 224 South Michigan Avenue, Chicato, IL, 60604, US

(21) Appl. No.: 10/360,901

(22) Filed: Feb. 7, 2003

Related U.S. Application Data
(62) Division of application No. 09/037,907, filed on Mar. 10, 1998.

(30) Foreign Application Priority Data
Mar. 12, 1997 (JP) P09-58102

(51) Int. Cl. B32B 3/00

(52) U.S. Cl. 428/195

(57) ABSTRACT

An image formed product obtained by recording visually recognizable information on at least one surface of an image receiving sheet having a substrate comprising a thermal shrinkage plastic sheet, followed by heating thus recorded image receiving sheet to cause thermal shrinkage, wherein the visually recognizable information is recorded by a recording method enabling to convert an input multiple visual information into electrical signal, and to control the electrical signal so as to synthesize and output image.

### FIELD OF THE INVENTION

The present invention relates to an image formed product in which a visual information such as letters or image is recorded by recording method enabling to synthesize and output image from multiple visual information (for example, thermal transfer method). The image formed product of the present invention is used as, for example, an accessory. In particular, the image formed product of the present invention is appropriately applied to an automatic machine to produce easily and quickly an accessory with a desired original design in a recreational facility.

### BACKGROUND OF THE INVENTION

Recently, there has been prevailed an automatic machinery to combine a portrait of a person to be pictured with a background frame selected at will among a stock of the back grounds so as to form a synthesized image, and to output that synthesized image on the surface of an adhesive sheet in a recreational facility such as an amusement park and a game-arcade. By the above machinery, the adhesive sheet with an original design to satisfy each customer's taste can be made easily and quickly, thus widely accepted with favor in the recreational facility or the like.

On the other hand, there is disclosed in Japanese Patent Publication (KOHKOKU) No. 59-13969 that an accessory such as a pendant or nameplate is made through the process to record a visual information such as letters, pictures, or image on a thermal shrinkage plastic sheet by hands, printing or the like, and to heat thus recorded visual information by an oven or the like so as to cause thermal shrinkage.

However, it has not been done as yet that an accessory is made from a thermal shrinkage plastic sheet in a recreational facility and provided the thus formed accessory there right away.

### SUMMARY OF THE INVENTION

The following conditions is required in order to make and provide an accessory with the use of a thermal shrinkage plastic sheet in a recreational facility:

(1) It is necessary to be able to make quickly and easily an accessory with an original design in response to many different kinds of orders.

(2) It is necessary to be able to design freely in wide extent and to combine various kinds of font, figure and image with each other.

(3) It is necessary to take a picture of the customer's figure and to incorporate thus made image into the design of the back ground when an accessory is made.

Furthermore, it is preferable to satisfy the following conditions:

(4) It is preferable that the image of the customer's figure incorporated into the design has a high quality of image comparable to a photograph.

(5) It is preferable that the resultant accessory such as the pendant or nameplate is excellent in durability and weather-proof as far as possible, since the accessory is exposed to various conditions in the open air.

The present invention was made in view of the above circumstances. The object of the present invention is to provide an image formed product having a thermal shrinkage plastic sheet as an essential material thereof, designed freely in wide extent, and easily and quickly made.

There is provided in the present invention an image formed product obtained by recording visually recognizable information on at least one surface of an image receiving sheet having a substrate comprising a thermal shrinkage plastic sheet, followed by heating thus recorded image receiving sheet to cause thermal shrinkage, wherein the visually recognizable information is recorded by a recording method enabling to convert an input multiple visual information into electrical signal, and to control the electrical signal so as to synthesize and output an image.

The visually recognizable information such as letter, figure and image, which was added to the image formed product of the invention, is output on the image receiving sheet by the output means such as a digital color printer or the like. More specifically, a plurality of visual information input by different input systems (for example, the image of the customer's figure taken in real time, the background frame selected among the previously stock background frames, the letters input by keyboard), or a plurality of visual information sequentially input by the same input means are converted into electric signals, then, thus converted electric signals are centrally controlled by the input signal control means and synthesized, and then, thus synthesized visual information is output on the image receiving sheet by the output means such as a digital color printer or the like. Furthermore, the customer's figure or other reflected matter taken by a digital camera, video camera or the like can be incorporated in the image formed product of the invention. Those customer's figure or other reflected matter can be taken and input immediately in process of manufacturing the image formed product.

Furthermore, since the above-mentioned image receiving sheet is mainly composed of a thermal shrinkage plastic sheet, when the image receiving sheet with the visual information recorded is heated under required conditions, the image receiving sheet with the visual information recorded is easily and quickly shrunk to cause the image to be smaller and elaborate. Accordingly, thus obtained image formed product has a high quality of image.

The image formed product of the present invention can be freely designed in wide extent. The taken image of the customer's figure can be incorporated in the design of the image formed product. The image formed product can be made easily and quickly in any place in response to many different kinds of orders. Furthermore, the image formed product can be provided in accordance with the requirement in the recreational facilities such as the amusement park.

Of the image formed product of the invention, one having the visual image recorded by a sublimation thermal transfer method has a clear image, and is excellent in the reproduction and gradation of intermediate colors, since the sublimation dye is excellent in transparency, thus obtaining a high quality of image comparable to the photograph.

Since the visual information recorded on the image receiving sheet is reduced in size through the heating and shrinking treatment upon making the image formed product of the invention, the image density thereof before the shrinkage is adjusted in order to fit the image density at completion. When the shrinkage rate of the image receiving sheet is large, the image density before the shrinkage is required to be adjusted to considerably low. As the result, it comes difficult to control the reproduction and gradation of the colors in a area from the intermediate gradation part to the highlight part. Even in those case, the excellent gradation and reproduction of colors can be attained by recording the information according to the sublimation thermal transfer method.

Furthermore, since the sublimation dye is reheated in the process of heating and shrinking to be firmly fixed, the obtained image formed product is excellent in preservation.

When the visually recognizable information is recorded on the image receiving sheet by the sublimation thermal transfer method, it may be directly recorded on the substrate comprising the thermal shrinkage plastic sheet, or it may be recorded on a dye receptor layer disposed on the substrate.

In general, when the image is directly recorded on the substrate by the sublimation thermal transfer method, the dye fixing property is inclined to be inferior to that of the case in which the image is recorded on the dye receptor layer by the sublimation thermal transfer method, in addition, there may be the case in which the image density at the transferred time is remarkably low. However, since the image formed product of the invention is produced by recording the visual information on the image receiving sheet, and then heating and shrinking the image receiving sheet, the transferred image is reduced in size and elaborated, thus the image density becomes dense. Accordingly, even though the dye fixing property of the sublimation dye is low to the substrate, the image density of the obtained image formed product can be adjusted to an appropriate level.

When the image is recorded on the dye receptor layer by the sublimation thermal transfer method, it is easier to adjust the tone of a color which is made by laying each color such as yellow, magenta, cyan over each other in comparison with the case in which the image is directly recorded on the substrate by the sublimation thermal transfer method. Furthermore, since the image formed by the sublimation thermal transfer method is excellent in durability in comparison with the image formed by the other recording methods, the obtained image formed product has an excellent durability. The durability becomes a remarkable merit when the image formed product is used as an accessory.

To dispose the dye receptor layer on the substrate, a coating liquid for the dye receptor layer may be applied on the substrate. However, there may be the case in which the substrate is inclined to be deteriorated by the solvent contained in the coating liquid for the dye receptor layer. In the above case, the dye receptor layer, on the substrate may be formed by transferring from the dye receptor layer transfer sheet to the surface of the substrate.

In the image formed product of the invention, there can be disposed a protect layer to improve durability and weather-proof. The above protect layer is particularly preferable when the image formed product is used as an accessory.

### BRIEF DESCRIPTION OF THE DRAWINGS

FIG. 1 is a schematic sectional view illustrating an embodiment of the image formed product of the present invention;

FIG. 2 is a schematic sectional view illustrating another embodiment of the image formed product of the present invention;

FIG. 3 is a schematic sectional view illustrating another embodiment of the image formed product of the present invention; and

FIG. 4 is a schematic sectional view illustrating another embodiment of the image formed product of the present invention.

### DETAILED DESCRIPTION OF PREFERRED EMBODIMENTS

The image formed product of the present invention is obtained by: (1) recording a visually recognizable information on at least one surface of an image receiving sheet having a substrate comprising a thermal shrinkage plastic sheet by a recording method enabling to convert an input multiple visual information into electric signals and to control thus converted electric signals so as to synthesize and output image, and then (2) heating thus recorded image receiving sheet to cause thermal shrinkage.

In one embodiment, the image formed product of the invention is manufactured as follows:

A substrate for an image receiving sheet comprising biaxial stretched polystyrene sheet, which is stretched to the required magnification, is prepared. In addition, an integral type sublimation thermal transfer sheet is prepared by disposing a dye receptor layer, a sublimation dye layer of each color (yellow, magenta, cyan or the like), and a protect layer in this order on one surface of another substrate, which is different from the substrate for an image receiving sheet. Then, the dye receptor layer is at first transferred onto the above substrate for the image receiving sheet, then the dye is transferred from the dye layer onto the dye receptor layer formed on the image receiving sheet so as to record a visual information of the image or the like, and then, the protect layer is transferred onto the area on which the above image or the like is recorded. The dye receptor layer, the dye layer and the protect layer can be transferred by the use of the same output device (for example, a thermal head). When the thus obtained semi-finished product is subjected to a heating and shrinking treatment by an oven or the like, the semi-finished product is converted to the image formed product of the invention. In the heating and shrinking treatment, the image receiving sheet is reduced in size (i.e., sheet area) and at the same time the thickness of the sheet is increased, thus becoming a plate shape.

The method using the above integral type thermal transfer sheet is suitable for a case in which the accessories are easily and quickly made and provided at once at homes or recreational facilities.

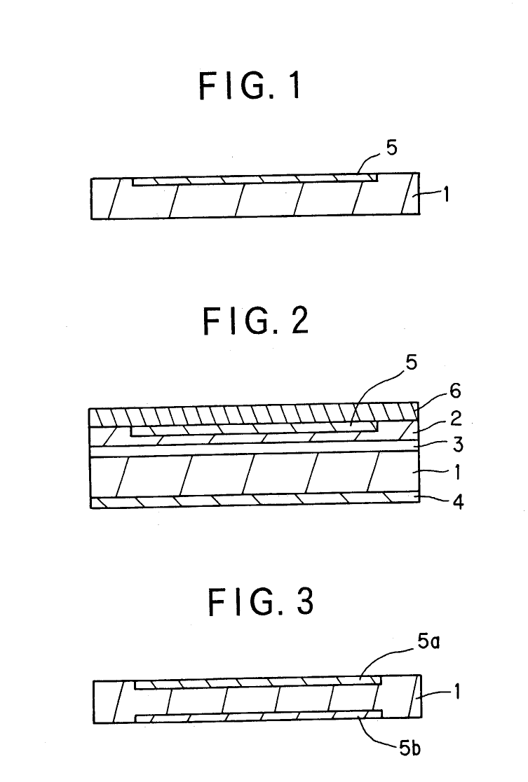

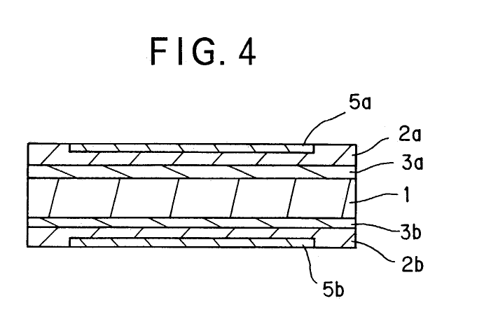

FIGS. 1 to 4 are schematic sectional views illustrating embodiments of the image formed product of the present invention. FIG. 1 shows the image formed product manufactured by directly recording by thermal transfer, as indicated by a reference numeral 5 in FIG. 1, on one surface of the image receiving sheet having a structure of substrate 1 per se comprising a thermal shrinkage plastic sheet, then being subjected to the heating and shrinking treatment. FIG. 2 shows the image formed product manufactured by preparing at first the image receiving sheet, which is prepared by disposing an intermediate layer 3 and a dye receptor layer 2 on one surface of the substrate 1 comprising a thermal shrinkage plastic sheet in this order, and disposing a back surface layer 4 on the other surface of the substrate 1, and then recording by thermal transfer, as indicated by a reference numeral 5 in FIG. 2, on the dye receptor layer 2 of the thus prepared image receiving sheet, then further disposing the protect layer 6 on the portion on which the image or the like is recorded, and then being subjected to the heating and shrinking treatment. FIG. 3 shows the image formed product manufactured by directly recording by thermal transfer, as indicated by reference numerals 5a, 5b in FIG. 3, on both surface of the image receiving sheet having a structure of substrate 1 per se comprising a thermal shrinkage plastic sheet, then being subjected to the heating and shrinking treatment. FIG. 4 shows the image formed product manufactured by preparing at first the image receiving sheet, which is prepared by disposing an intermediate layer 3a, 3b and a dye receptor layer 2a, 2b on respective surfaces of the substrate 1 comprising a thermal shrinkage plastic sheet in this order, and then recording by thermal transfer, as indicated by reference numerals 5a, 5b in FIG. 4, on each of the dye receptor layer 2a, 2b of the thus prepared image receiving sheet, and then being subjected to the heating and shrinking treatment.

The image receiving sheet, a thermal transfer method, protect layer and heating and shrinking treatment are described hereunder.

(1) Image receiving sheet (Imageable sheet)

The image receiving sheet has only a substrate comprising a thermal shrinkage plastic sheet, as its simplest structure. There may be disposed additional layers such as a dye receptor layer 2, intermediate layer 3, back surface layer 4 on the substrate of the image receiving sheet. There may be disposed more than two different layers as the intermediate layer. The visual information 5 of the image or the like may be recorded on one surface side of the image receiving sheet, or on both surface sides of the image receiving sheet. When the image or the like is recorded on both surface sides of the image receiving sheet, the intermediate layer (hiding layer) is preferably disposed so that the image or the like of the opposite side is not looked through, or an opaque substrate is preferably used.

### [SUBSTRATE]

As the thermal shrinkage plastic sheet of the substrate of the image receiving sheet, for example, a biaxial stretched film comprising thermoplastic resin may be used. The biaxial stretched film comprising thermoplastic resin has the characteristic in which the stretched film almost exactly returns to the size before being stretched, when heated at the temperature higher than the temperature in the process of being stretched. More specifically, stretched films comprising such as polystyrene, high impact polystyrene, ABS resin, polyvinyl chloride, AS resin, PMMA resin, P.D.P.E or the like are shown for examples. It is preferable to use the stretched film comprising polystyrene among the above. The thickness of the stretched film is usually within a range from 50 to 500 μm. Usually, the stretched film, in which its length and width are stretched 2 to 10 times in respective longitudinal and width directions, is used. When the film is poorly stretched, it may lose the merit in which the elaborate image can be obtained by transferring large image or letters on the image receiving sheet and being subjected to heating and shrinking treatment. On the other hand, when the film is over stretched, it is difficult to control the size in shrinkage.

The thermal shrinkage plastic sheet or the image receiving sheet may be transparent or opaque, furthermore, it may colored. The thermal shrinkage plastic sheet or the image receiving sheet may be worked in advance in accordance with the shape of the completed image formed product. For example, the thermal shrinkage plastic sheet or the image receiving sheet may be stamped out so as to form a desired shape, or a hole for hanging may be punched out, furthermore, a notch may be formed in advance.

### [DYE RECEPTOR LAYER]

An image receptor layer (imageable layer) such as the dye receptor layer is required to be disposed when the substrate has no fixing property or very-low fixing property to a color material such as sublimation dye, ink or the like. For example, in a case of the recording method to blow the ink on the image receiving sheet such as ink-jet recording type, it is practically impossible to directly form the image on the substrate, thus the ink receptor layer is required to be disposed. Although the sublimation thermal transfer method does not necessarily require the dye receptor layer, when the recording is carried out by the sublimation thermal transfer on the dye receptor layer, it is easy to adjust the tone of the color which is made by laying each color of yellow, magenta, cyan or the like in comparison with the case of direct recording on the substrate by the sublimation thermal transfer.

In the present invention, an appropriate dye receptor layer or color material layer may be chosen and used among the well known dye receptor layers and color material layers, in accordance with the selected recording method. The dye receptor layer is formed by coating the coating liquid for the receptor layer on the substrate or intermediate layer, and being dried, which coating liquid for the receptor layer is prepared by dissolving the resin for the receptor layer and other elements into an appropriate organic solvent, or dispersing the resin for the receptor layer and other elements into an appropriate organic solvent or water. In the thermal shrinkage plastic sheet as the substrate, there is, for example, polystyrene sheet which has low resistance to organic solvent. When it is difficult to apply the coating liquid for the receptor layer on the surface of the substrate or intermediate layer because of the low resistance to solvent thereof, it is possible to transfer the receptor layer to the substrate of the image receiving sheet or intermediate layer from the dye receptor layer transfer sheet which is prepared in advance by applying the dye receptor liquid onto another substrate. The transfer of the dye receptor layer may be carried out at the time of preparing the image receiving sheet, or immediately before transferring the image or the like on the image receiving sheet by the output device (for example a thermal head) of the printer.

The visual information such as the image or the like may be output to the receptor layer on the dye receptor layer transfer sheet, and then the receptor layer may be transferred to the image receiving sheet. Usually, the reversing image is output to the receptor layer on the dye receptor layer transfer sheet, and then the receptor layer is transferred to the image receiving sheet to obtain the correct image.

### [INTERMEDIATE LAYER]

The intermediate layer 3 is disposed to provide various kinds of property to the image receiving sheet. For example, properties such as adhesiveness between layers, brightness, cushion property, antistatic property, hiding property to shut the image or the like of the opposite side can be provided by the intermediate layer. Appropriate intermediate layer may be selected among the known intermediate layers and used.

### [BACK SURFACE LAYER]

The back surface layer 4 may be disposed on the back surface side of the image receiving sheet to provide conveying property or antistatic property. Appropriate back surface layer may be selected among the known back surface layers and used.

(2) Recording by thermal transfer method

In order to make the image formed product of the present invention, the visually recognizable information is recorded on the surface of the image receiving sheet mainly composed of the thermal shrinkage plastic sheet by the recording method enabling to easily prepare the synthesized image and output same.

More specifically, a plurality of visual information input by different input systems (for example, the image of the customer's figure taken in real time, the background frame selected from the previously stock background frames, the letters input by keyboard), or a plurality of visual information sequentially input by the same input means are converted into electric signals, then, thus converted electric signals are centrally controlled by the input signal control means and synthesized, and then, thus synthesized visual information is output on the image receiving sheet by the output means such as a color video printer, a digital color printer or the like. Furthermore, the customer's figure or other reflected matter taken by a digital camera, video camera or the like can be incorporated in the synthesized image. Accordingly, the recording of the visual information by the thermal transfer method can be designed freely in wide extent, in addition, the image formed product with the original design can be made easily and quickly in response to the customer's order or requirement.

The recording to the image receiving sheet may be carried out in such a manner that the visual information such as the image or the like is output to the receptor layer on the dye receptor layer transfer sheet (intermediate transfer recording medium), and then, the dye receptor layer is transferred onto the substrate or intermediate layer of the image receiving sheet.

When the shrinking rates of the image receiving sheet in the longitudinal direction and in the width direction are different upon being heated, it is necessary to correct the image to be recorded on the image receiving sheet so as not to cause distortion after heating and shrinking treatment. In addition, the reversing image or intentionally distorted image may be output to the image receiving sheet.

Since the visual information recorded on the image receiving sheet is heated and shrunk so as to be reduced in size upon making the image formed product of the invention, and the image density thereof becomes higher accordingly, it is necessary to set up the image density lower at output in order to adjust the image density at completion. Since the image density at output can be set up lower, the amount of the dye to be used is small.

There may be shown as an example of the specific recording method, for example, a thermal transfer method (sublimation thermal transfer method, fusion thermal transfer method), inkjet type, thermal color generating method. Any recording method may be used, however, the sublimation thermal transfer method is preferably used to manufacture the image formed product of the invention.

When the sublimation thermal transfer method is used, the obtained image is clear, and since the sublimation dye is excellent in transparency, the obtained image is excellent in the reproduction and gradation of the intermediate colors, thus the high quality of image comparable to the photograph can be obtained.

When the image formed product of the present invention is manufactured, the image density before the shrinkage is adjusted to fit to the image density at the completion. When the shrinkage rate of the image receiving sheet is large, the image density before the shrinkage is required to adjust to considerably low. As the result, it comes difficult to control the reproduction and gradation of the colors in a area from the intermediate gradation part to the highlight part. Even in those case, the excellent reproduction and gradation of the colors can be attained by recording the information according to the sublimation thermal transfer method. Furthermore, since the sublimation dye is reheated in the process of heating and shrinking to be firmly fixed, the obtained image formed product is excellent in preservation.

On the contrary, when the inkjet method is used, since the image is output with dot-gradation, the image quality is inferior to that of the sublimation thermal transfer. When the fusion transfer method is used, in addition to that the image is output with dot gradation, the color has no transparency and has inclination to be darkened (the portion in which colors are layered is darkened in particular), thus the image is inferior to that of the sublimation thermal transfer.

The sublimation thermal transfer method has a merit that the visual information such as the image or the like may be directly recorded on the substrate. On the contrary, when the jet-ink method is used, it is impossible to directly record the image or the like on the substrate, thus the receptor layer is required to be disposed.

Furthermore, the inventors found that when the sublimation thermal transfer method is directly applied on the substrate to manufacture the image formed product of the present invention, even the substrate having low dye fixing property can be used. It is known that the image or the like can be directly transferred on the substrate by the sublimation thermal transfer. However, when the usual printing product is formed by the sublimation thermal transfer method, it is practically difficult to directly transfer on the substrate having low dye fixing property. In order to make up for the shortage of the dye fixing property in the substrate, a high energy has to be charged upon thermal transferring. As a result, the high heating energy causes various problems such as (1) damage of the image receiving sheet such as distortion or rugged surface thereof, (2) damage of the transfer sheet such as a heat fusion to the thermal head, and (3) sticking between the image receiving sheet and the transfer sheet. On the contrary, when the image formed product of the present invention is manufactured, since the image receiving sheet is heated and shrunk after formation of the image, the image is reduced in size, and accordingly the image density is risen, thus the image quality becomes clear without the high heating energy. Even the substrate having too low dye fixing property to form the general printing product, it can be used without problems in making the image formed product of the present invention.

The visual information such as the image or the like may be recorded not directly on the substrate, but on the dye receptor layer of the image receiving sheet or the dye receptor layer of the dye receptor layer transfer sheet by the sublimation thermal transfer method. The image formed product of the invention is used for example an accessory such as a pendant or a key holder, which is exposed to the various kinds of out door circumstances. The image formed product of the invention is therefore preferable to have more excellent durability and weather proof than the general printing product. In this connection, since the dye receptor layer used in the sublimation thermal transfer method has excellent durability and weather proof, the image formed product of the invention can be provided with the excellent durability and weather proof. On the other hand, since the dye receptor layer used in the inkjet method may have an unsatisfactory water proof, the dye receptor layer is inclined to have inferior durability and weather proof to that used in the sublimation thermal transfer. Since the image or letter recorded by the fusion transfer method is formed by the thermal fusion binder such as a wax, the image or letter recorded is inferior in durability and weather proof to the dye receptor layer used in the sublimation thermal transfer.

(3) Protect layer

The image formed product of the invention is used for example an accessory such as a pendant or a key holder, which is exposed to the various kinds of out door circumstances. The image formed product of the invention is therefore preferable to have more excellent durability and weather proof than the general printing product. In this connection, it is preferable in the image formed product of the invention to dispose the protect layer to cover the area where the visual information such as image or letter is recorded.

The protect layer may be selected among the known protect layers and used. The protect layer may be formed by the various resin excellent in wear resistance, resistance to chemicals, transparency, hardness or the like, for example, polyester resin, polystyrene resin, acrylic resin, polyurethane resin, acrylic urethane resin, silicone modified resins of the above, or the mixture of the above resin.

The protect layer may be formed either before or after heating and shrinking treatment, if the visual information such as image or letter is already formed on the image receiving sheet. As the method of forming the protect layer, there is for example a method in which the protect layer is transferred from the protect layer transfer sheet, in which the transferable protect layer disposed on the substrate, to the image receiving sheet. According to this method, the image formed product of the invention is easily and quickly made and provided in the recreation facilities or homes.

As the protect layer transfer sheet, there may be used the single type transfer sheet in which only the protect layer can be transferred, or the integral type transfer sheet in which the receptor layer, the dye layer (yellow, magenta, cyan or the like) and the protect layer are disposed on a single substrate in this order, and each of those layers can be transferred.

(4) Heating and shrinking treatment

The image formed product of the invention can be obtained by subjecting the image receiving sheet, on which the visual information such as image, letter or the like is already recorded, to the heating and shrinking process with the use of the heating apparatus such as an oven. When the image receiving sheet is heated and shrunk, the sheet area is reduced in size while the sheet thickness is increased, thus the image receiving sheet is changed from the sheet type to the plate type. Furthermore, since size of the visual information formed on the image formed product is reduced to one several (one fourth or one fifth, for example) to the visual information before the heating and shrinking treatment, the shrunk visual information is clear and elaborate in comparison with the image as output by the thermal transfer.

In general, the image receiving sheet is heated in the heating and shrinking treatment for a couple of minutes at the temperature higher than the temperature when the thermal shrinkage plastic sheet as the substrate is stretched to work. The heating temperature is preferably at least the glass transition point of the thermal shrinkage plastic sheet as the substrate and up to the thermal working temperature or thermal deformation temperature.

### EXAMPLE

The present invention is described in more detail with the example and the comparison.

### [Example 1]

As the substrate sheet, a transparent biaxial stretched polystyrene sheet having a thickness of 210 μm is used, and the image is directly formed on the substrate sheet by a sublimation transfer type card printer (CP-510, manufactured by Dai Nippon Printing Co., Ltd.) with the use of an ink ribbon with the ink layer of yellow, magenta, cyan and black disposed in this order.

The hole for being suspended is punched on the corner of thus printed sheet, and the printed sheet was heated for three minutes in the oven at the temperature of 150° C. to prepare the image formed product of the invention. As a result, the substrate sheet with the formed image was shrunk to about one third in both of the longitudinal direction and width direction, and the thickness thereof became about 2 mm. The density of the image (transparent density) increased from 0.4 (before heated) to 2.5 (after heated), thus reached at the practical level. The image formed product excellent in durability and preservation, and having very high quality was obtained.

### [Example 2]

The image formed product of the invention was obtained by the same manner as in Example 1 except that the biaxial stretched polystyrene sheet having a thickness of 300 μm is used as the substrate sheet. As a result, the substrate sheet with the formed image was shrunk to about two fifth in both of the longitudinal direction and width direction, and the thickness thereof became about 2 mm. The density of the image reached at the practical level. The image formed product excellent in durability and preservation, and having very high quality was obtained, as similar as in Example 1.

### [Example 3]

As the substrate sheet of the receptor layer transfer film, the releasable PET film having a thickness of 50 μm is used. On a surface of the above film to which a release treatment is subjected, the coating liquid for the receptor layer having the following composition is applied by Mayer bar and dried so as for the thickness thereof to be 2.5 μm after dried. On the thus formed receptor layer, the coating liquid for the white color layer having the following composition is applied and dried so as for the thickness thereof to be 2.0 μm after dried. Furthermore, on the thus formed white color layer, the coating liquid for the adhesion layer having the following composition is applied and dried so as for the thickness thereof to be 5.0 μm after dried to obtain the receptor layer transfer film.

| <Coating liquid for the receptor layer> | | |
|---|---|---|
| Vinyl chloride vinyl acetate copolymer resin | 20.0 | weight parts |
| (#1000MT2, manufactured by Denki Kagaku Kogyo | | |
| Co., Ltd.) | | |
| Amino-modified silicone (KS-343, manufactured | 0.2 | weight parts |
| by Shinetsu Kagaku Kogyo Co., Ltd.) | | |
| Epoxy-modified silicone (KF-393, manufactured | 0.2 | weight parts |
| by Shinetsu Kagaku Kogyo Co., Ltd.) | | |
| Methyl ethyl ketone (MEK) | 79.6 | weight parts |
| <Coating liquid for the white color layer> | | |
| Polyester resin (WR905, manufactured by Nihon | 10.0 | weight parts |
| Gosei Kagaku Kogyo Co., Ltd.) | | |
| Titanium oxide | 20.0 | weight parts |
| Water/Isopropyl alcohol (IPA) = 2/1 | 70.0 | weight parts |
| <Coating liquid for the adhesion layer> | | |
| Acrylic adhesive agent (SK DYNE 82, | 25.0 | weight parts |
| manufactured by Soken Kagaku kogyo Co., Ltd.) | | |
| Hardening agent (D-90, manufactured by | 5.0 | weight parts |
| Soken Kagaku Kogyo Co., Ltd.) | | |
| MEK/toluene = 1/1 | 70.0 | weight parts |

The above receptor layer transfer film and the biaxial stretched polystyrene sheet having a thickness of 210 μm as the substrate sheet were stacked each other, then the releasable PET was released to form the receptor layer on the substrate sheet.

Thus obtained image receiving sheet was used, and the image was formed in the same manner as in Example 1, and the thus printed sheet was subjected to the heating treatment to obtain the image formed product of the invention. In the obtained image formed product, there was disposed the white color hiding layer, thus having a favorable looking and texture. Furthermore, since the receptor layer was disposed, the image formed product had a high quality of color matching and image.

### [Example 4]

The image formed product of the invention was obtained by the same manner as in Example 3 except that the white color layer was not disposed. Due to the receptor layer disposed, the obtained image formed product had a high quality of color matching and image as similar as in Example 3.

### [Example 5]

The image formed product of the invention was obtained by the same manner as in Example 1 except that the mat treatment was applied to one surface of the substrate sheet and the image was formed on the other surface thereof The obtained image formed product had a texture of a cloudy glass.

### [Example 6]

The image formed product of the invention was obtained by the same manner as in Example 1 except that the ink ribbon with yellow, magenta, cyan, black and protect layer disposed in this order was used. The obtained image formed product had more excellent durability and preservation than that in Example 1.

### [Example 7]

The image formed product of the invention was obtained by the same manner as in Example 1 except that the white biaxial stretched polystyrene sheet having a thickness of 210 μm was used as the substrate sheet, and the image was formed on both surfaces of the substrate sheet. Since the image was formed on both surfaces, the obtained image formed product had a very high designing.

### [Example 8]

As the substrate sheet for the intermediate transfer recording medium, a PET film having a thickness of 6 μm was used. The coating liquid for the back surface layer having the following composition was applied on one surface of the above substrate film by Mayer bar, and dried so as for the thickness to be 1 μm after dried, thus forming the back surface layer.

<Coating liquid for the back surface layer>

| | | |
|---|---|---|
| Polyvinyl butyral resin (ETHLEC BX-1, | 8.0 | weight parts |
| manufactured by Sekisui Kagaku Kogyo Co., Ltd.) | | |
| Polyisocyanate hardening agent (BARNOCK D750, | 18.0 | weight parts |
| manufactured by Dai Nihon Ink Kagaku Kogyo Co., | | |
| Ltd.) | | |
| Slipping agent (PLYSURF A208S, manufactured by | 5.0 | weight parts |
| Daiichi Kogyo Seiyaku Co., Ltd.) | | |
| Talc | 2.0 | weight parts |
| MEK/toluene = 1/1 | 130 | weight parts |

Then, on the other surface side of the above substrate film with the back surface layer formed, the coating liquid for the release layer having the following composition was applied by Mayer bar, and dried so as for the thickness to be 1 μm after dried, thus forming the release layer. The coating liquid for the image protect layer having the following composition was applied on the thus formed release layer, and dried so as for the thickness to be 3 μm after dried, thus forming the image protect layer. The coating liquid for the image receptor layer having the following composition was applied on the thus formed image protect layer, and dried so as for the thickness to be 5 μm after dried, thus obtaining the intermediate transfer recording medium.

| <Coating liquid for the release layer> | | |
|---|---|---|
| Silicone resin varnish (KS770A, manufactured by | 50.0 | weight parts |
| Shinetsu Kagaku Kogyo Co., Ltd.) | | |
| Toluene | 50.0 | weight parts |
| <Coating liquid for the protect layer> | | |
| Acrylic resin (BR-85, manufactured by Mitsubishi | 20.0 | weight parts |
| Rayon Co., Ltd.) | | |
| MEK | 80.0 | weight parts |
| <Coating liquid for the receptor layer> | | |
| Vinyl chloride vinyl acetate copolymer resin | 17.0 | weight parts |
| (VYHD, manufactured by Union Carbide Co., Ltd.) | | |
| Amino-modified silicone (KS-343, manufactured | 0.17 | weight parts |
| by Shinetsu Kagaku Kogyo Co., Ltd.) | | |
| Epoxy-modified silicone (KF-393, manufactured | 0.17 | weight parts |
| by Shinetsu Kagaku Kogyo Co., Ltd.) | | |
| Methyl ethyl ketone (MEK) | 82.6 | weight parts |

The receptor layer side of the thus formed intermediate transfer recording medium and the ink ribbon were placed face to face, and thus layered intermediate transfer recording medium and the ink ribbon were heated by the thermal head from the back surface of the ink ribbon to form the image.

Then, the image receptor surface of the intermediate transfer recording medium with the image formed and the substrate sheet used in Example 1 were placed face to face. Then, thus layered intermediate transfer recording medium and the substrate sheet were heated by the thermal head from the back surface of the intermediate transfer recording medium, thus the image receptor layer of the intermediate transfer recording medium and the substrate sheet were adhered. Then, the PET film of the intermediate transfer recording medium was released. As a result, the image was formed on the substrate.

The sheet with the image thus formed was subjected to the heating treatment in the same manner as in Example 1, to obtain the image formed product of the invention. The obtained image formed product was very excellent in durability since the image was protected by the protect layer.

### [Comparison 1]

The image formed product was obtained by the same manner as described in Example 1 except that the fusion transfer type printer (MD4000J, manufactured by Alps Electric Co., Ltd.) was used. As a result, even though the image was obtained, the image had no transparency and looked darkened. Furthermore, the image was inferior in durability, and easily scraped off.

### [Comparison 2]

It was tried to obtain the image formed product by the same manner as described in Example 1 except that the ink-jet printer (BJC-420J, manufactured by Canon Co., Ltd.) was used. However, the ink was smeared on the substrate sheet to fail to form the image.

### [Comparison 3]

The image receiving sheet was formed by the same manner as described in Comparison 2 except that the coating liquid for the receptor layer having the following composition was applied on one surface of the substrate sheet by Mayer bar, and dried so as for the thickness to be 10 μm after dried, then it was tried to form the image. As a result, the receptor layer was inferior in water resistance, and when the water was attached thereto, the image receptor layer was melt to smear the image.

<Coating liquid for the receptor layer>

| | | |
|---|---|---|
| PVA (#217, manufactured by Kurare Co., Ltd.) | 10.0 | weight parts, |
| Water/IPA = 9/1 | 90.0 | weight parts. |

As described in detail, the image formed product of the invention is obtained by recording the image, letter or the like on the image receiving sheet mainly composed of the thermal shrinkage plastic sheet by the recording method enabling to easily record the synthesized image, and then being subjected to the heating and shrinking treatment. As a result, the image formed product of the invention can be designed freely in wide extent, and is suitable to be easily and quickly made and provided.

Furthermore, it is possible to incorporate the various visual information such as images, patterns, symbols, letters in the design and to freely combine the same, and even to incorporate the image or photograph taken during making of the image formed product. Furthermore, it is possible to add the editing such as the reversing of the image or change of the size in addition to the above.

When the image formed product of the invention is manufactured, the visual information is minified or shrunk after the recording. As a result, even when the complex image is transferred, the image is clear and elaborate.

The image formed product of the invention can be used for example as accessories such as pendants, key holders, name plates or the like. It is suitably used in such fields as homes or recreational facilities where the original design is freely created with fun, and the accessories are easily and quickly made and provided.

Among the image formed products of the invention, the image formed product in which the image or the like is recorded by the sublimation thermal transfer method has not only a high quality of image comparable to the photograph, but also a merit that the image can be directly recorded on the substrate, and is excellent in durability and weather proof, thus especially suitable for being used as accessories.

Furthermore, when the protect layer is disposed on the image formed product of the invention to enhance the durability and weather proof, the evaluation of the usage as accessories can be further raised.

1. A method for manufacturing an image formed product, which comprises recording visually recognizable information on at least one surface of an image receiving sheet comprising a substrate of a thermal shrinkable plastic, and heating the recorded image receiving sheet to cause thermal shrinkage, wherein the visually recognizable information is recorded by a recording method enabling to convert an input multiple visual information into electrical signal, and to control said electrical signal so as to synthesize and output an image.

2. A method according to claim 1, wherein said visually recognizable information is recorded by a sublimation thermal transfer method.

3. An image formed product manufactured by the method of claim 1.

4. An image formed product manufactured by the method of claim 2.
